(19) United States
(12) Patent Application Publication
(10) Pub. No.: US 2022/0112101 A1
(43) Pub. Date: Apr. 14, 2022

(54) BRINE TANKS

(71) Applicant: PURONICS, LLC, Livermore, CA (US)

(72) Inventors: Scott BATISTE, Danville, CA (US); John GULLIFORD, Livermore, CA (US)

(21) Appl. No.: 17/066,327

(22) Filed: Oct. 8, 2020

(51) Int. Cl. C02F 1/42; B29C 45/16

(52) U.S. Cl. CPC C02F 1/42; B29C 49/00; C02F 2303/16; B29C 45/16

(57) ABSTRACT

Provided herein are improved brine tanks comprising a brine tank lid with two parts for customizable identification, and a brine tank body with one or more indentations for easier removal of the brine tank lid.

### BACKGROUND OF THE INVENTION

Water hardness is one of the most common water quality concerns reported by consumers. The most comment and effective way to eliminate the effects of hard water is to remove the minerals that cause water hardness via ion exchange using a water softener system. A water softener system may comprise a resin and a brine tank. The mineral ions that cause water hardness are captured by the resin and exchanged for sodium or potassium ions of a strong brine solution that is constituted in the brine tank.

Brine tanks may be located outdoors and may be exposed to weather elements, animals or other elements that may interfere with its function. In addition, brine tanks may need identifiers to distinguish between different tanks and containers, including other brine tanks. As such, brine tanks may benefit from further improvements.

### SUMMARY OF THE INVENTION

A need exists for improved brine tanks. For example, it may be desirable to provide brine tanks that may be able to withstand weather elements while also permitting a user to manually open the tank. A further need may exist for identifiers for brine tanks.

An aspect of the invention may be directed to a brine tank configured to generate brine solution and to support flow of brine solution to a water softener for regeneration of an ion-exchange resin. The brine tank may comprise: (a) a brine tank lid; and (b) a brine tank body, wherein the brine tank body comprises a plurality of indentations configured to allow an operator to apply a force to the brine tank lid and separate the brine tank lid from the brine tank body, and wherein the plurality of indentations are positioned to be at least partially exposed when the brine tank lid is attached to the brine tank body.

A further aspect of the invention may be directed to a residential water filtration system comprising a brine tank configured to generate brine solution for regeneration of ion-exchange resin, wherein the brine tank body comprises: (a) a brine tank lid; and (b) a brine tank body; wherein the brine tank body comprises a plurality of indentations configured to allow an operator to apply a force to the brine tank lid and separate the brine tank lid from the brine tank body, and wherein the plurality of indentations are positioned to be at least partially exposed when the brine tank lid is attached to the brine tank body.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 provides an exemplary embodiment of an assembled brine tank comprising a brink tank lid and a brine tank body;

FIG. 2 provides an exemplary embodiment of an assembled brine tank comprising indentations;

FIG. 3 provides an exemplary embodiment of an assembled brine tank;

FIG. 4 provides an exemplary brine tank lid with several fastening mechanism units;

FIG. 5 provides an exemplary brine tank lid with a label;

FIG. 6 provides an exemplary brine tank lid with several fastening mechanism units;

FIG. 7 provides an exemplary brine tank body with a ledge and indentations;

FIG. 8 provides an exemplary brine tank body with indentations;

FIG. 9 provides an exemplary brine tank body with a brine well; and

FIG. 10 provides an exemplary brine tank body.

### DETAILED DESCRIPTION OF THE INVENTION

Water softener systems may be used to remove minerals such as calcium and magnesium from water, thereby softening the water (making it less hard). The water softener systems can remove hardness-causing mineral ions by ion exchange. The mineral ions may be captured by an ion exchange resin and exchanged for sodium and/or potassium ions. The resulting soft water may contain no hardness-causing mineral ions.

The tank of a water softener system contains the ion-exchange resin which may be covered with sodium and/or potassium ions. As hard water passes through the tank, the ion-exchange resin attracts calcium and magnesium ions (i.e. hardness-causing mineral ions) in exchange for the sodium and/or potassium ions.

Eventually, the resin becomes saturated with the hardness-causing mineral ions and the ion exchange process no longer occurs. To recharge the ion-exchange resin, a strong brine solution comprising sodium and/or potassium ion may be flushed through the resin tank, immersing the resin in a high concentration of sodium and/or potassium ions. The sodium and/or potassium ions replace the calcium, magnesium and/or any other hardness-causing mineral ions on the resin, which may be then drained away. This regeneration process allows the resin to be recharged with sodium and/or potassium ions for further ion-exchange and the water softener may be ready to remove hardness-causing ions from hard water.

A brine tank may be useful for the regeneration process. The brine tank is a tank that may be separate from the resin-containing tank. The brine tank contains the potassium and/or sodium salt for making a strong brine (or salt) solution. Water may be added the sodium and/or potassium salt to constitute the brine solution for recharging the ion-exchange resin during regeneration. During regeneration, the brine solution flows through a cylindrical brine well within the brine tank to the water softener tank. Water may flow into and/or sit in the brine well; the filling of the brine well with water may take between about 1 minute to about 10 hours. The filling may take about 30 minutes or less. The filling may take about an hour or more. Subsequently, the brine water may be flown into the water softener tank (e.g., a resin tank) for the recharging process (or brining process). The recharging process may further comprise a cleaning step comprising flowing water through the water softener tank (e.g., a resin tank) to wash out (e.g., by flushing using fast flow water) brine and/or any residuals (e.g., dirt, heavy metals, sediments, etc.) from the resin.

Users (or operators) of brine tanks frequently replenish the sodium and/or potassium salt within the brine tank. A user/operator should be able to remove the lid from the brine tank with very little effort. However, a brine tank may be located outdoors, where the brine tank may be exposed to harsh weather conditions (e.g. strong winds, rain, snow etc). Under such conditions, the lid must be able to withstand weather elements and not blow off. As such, the means by which the lid may be coupled with the brine tank body may be critical for improved functionality and/or sanitation.

Moreover, brine tanks may need identifiers to distinguish one brine tank from another brine tank, and/or to distinguish a brine tank from other similar containers. Such identifiers may be located on the lid of a brine tank for better visibility.

Provided herein are improved brine tanks for better functionality. The brine tanks described herein have lids comprising two parts which allows for one or more customizable identifiers including the use of color as an identifier. In addition, the body of the brine tank may have one or more indentations that provide a means for a user or an operator to remove a tightly-fitted lid from the brine tank body.

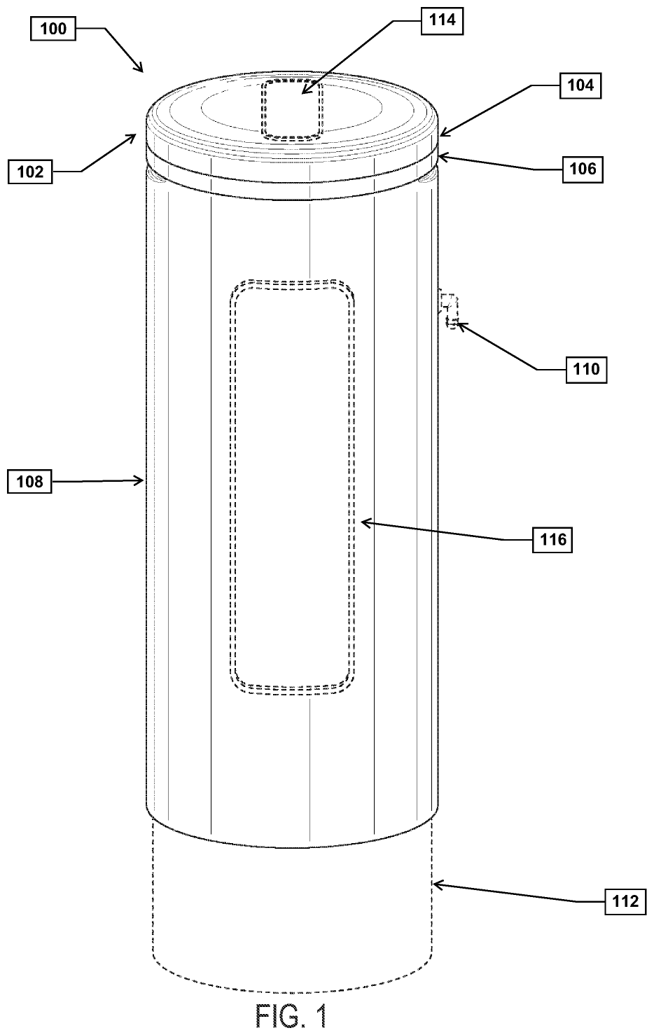

Various configurations pertaining to brine tanks of water softener systems will now be described with reference to the drawings. The assembled brine tank 100, shown in FIG. 1, may comprise a lid 102 and a tank body 108. The lid 102 may have two parts: the first part 104 and the second part 106. The first part 104 and the second part 106 may comprises the same material. The first part 104 and the second part 106 may comprises different materials. The first part 104 may be coupled to the second part 106 via one or more fastening mechanisms. The first part 104 may further comprise a label 114.

In some embodiments, the first part 104 and/or the second part 106 of the lid 102 may comprise one or more features that can be used as an identifier for the lid 102 and/or the brine tank 100. For example, the one or more features may be a color, an image, alphanumeric text, a symbol, a pattern, or a combination thereof. In some cases, one or more features on the first part 104 may be combined with one or more features on the second part 106 to form a unique identifier. For example, a visual property (e.g., a color) of the first part 104 may be different from a visual property (e.g., a color) of the second part 106 to form a unique identifier. In some embodiments, the unique identifier may comprise a difference in the color of the first part 104 and the second part 106.

In some cases, the identifier may be a color. In some embodiments, the first part 104 has a first color and the second part 106 has a second color. In some cases, the first color and the second color may be the same. In some cases, the first color and second color may be different. When the first color and the second color may be different, a user/operator may use that as a visual indicator for where the lid ends and the body begins, making it easier for the user to quickly spot where to lift the lid up. In some embodiments, a first color may denote the lid (e.g., the first part 104) and/or a second color may denote the edge of the lid (e.g., the second part 106); indentations may be positioned beneath the second color. This may help a user to detect a led an/or the indentations to open the lid. Additionally, when the first color and the second color may be different, the combination of colors may be used to quickly distinguish brine tanks produced by different manufacturers. This may be advantageous of other identifiers such as colored tape, which may lose the color and/or peel off over time.

In some cases, the first color and/or second color may be a color that may be perceptible to the human eye and may have a wavelength between about 390 nm and about 700 nm. In some cases, the color may be perceptible to the human eye upon exposure to electromagnetic radiation greater than 700 nm and/or less than 390 nm. In some instances, the difference of the first wavelength and the second length may be at least 50 nm. In some instances, the difference of the first wavelength and the second length may be between about 10 nm to about 500 nm. In some instances, the difference of the first wavelength and the second length may be about 10 nm to about 20 nm, about 10 nm to about 50 nm, about 10 nm to about 100 nm, about 10 nm to about 200 nm, about 10 nm to about 300 nm, about 10 nm to about 400 nm, about 10 nm to about 500 nm, about 20 nm to about 50 nm, about 20 nm to about 100 nm, about 20 nm to about 200 nm, about 20 nm to about 300 nm, about 20 nm to about 400 nm, about 20 nm to about 500 nm, about 50 nm to about 100 nm, about 50 nm to about 200 nm, about 50 nm to about 300 nm, about 50 nm to about 400 nm, about 50 nm to about 500 nm, about 100 nm to about 200 nm, about 100 nm to about 300 nm, about 100 nm to about 400 nm, about 100 nm to about 500 nm, about 200 nm to about 300 nm, about 200 nm to about 400 nm, about 200 nm to about 500 nm, about 300 nm to about 400 nm, about 300 nm to about 500 nm, or about 400 nm to about 500 nm. In some instances, the difference of the first wavelength and the second length may be about 10 nm, about 20 nm, about 50 nm, about 100 nm, about 200 nm, about 300 nm, about 400 nm, or about 500 nm. In some instances, the difference of the first wavelength and the second length may be at least about 10 nm, about 20 nm, about 50 nm, about 100 nm, about 200 nm, about 300 nm, about 400 nm, or more. In some instances, the difference of the first wavelength and the second length may be at most about 500 nm, about 400 nm, about 300 nm, about 200 nm, about 100 nm, about 50 nm, about 20 nm, about 10 nm, or less.

The cross-sectional shape of the brine tank body may be a circle, a square, a rectangle, a triangle, a hexagon, or a polygon. The brine tank body may be concave in part or in whole. The brine tank body may be convex in part or in whole. The brine tank body may have a cross-sectional area that may be substantially the same throughout, or a cross-sectional area that may vary along a length of the brine tank body. In some cases, the brine tank body may have a substantially cylindrical shape with a substantially constant cross-sectional area throughout the length of the brine tank body. In some embodiments, the brine tank body may have a cross-sectional area that may be larger in an upper or a lower part of the tank. In some embodiments, an upper part of the tank may have a larger cross-sectional area than a lower part. In some embodiments, an upper part of the tank may have a smaller cross-sectional area than a lower part. In some embodiments, the upper part may be equal in length to the lower part or may have a different length than the lower part. In some embodiments, the cross-sectional area of the tank body may increase or decrease in a substantially linearly across the length of the tank body. In some embodiments, the cross-sectional area of the tank body may increase or decrease in a non-linearly across the length of the tank body.

The brine tank body may have a volumetric capacity on the order of about 1 gallon, about 10 gallons, about 100 gallons or about 1000 gallons. The brine tank body may have a volumetric capacity of at least about 1 gallon, 2 gallons, 3 gallons, 4 gallons, 5 gallons, 6 gallons, 8 gallons, 10 gallons, 15 gallons, 20 gallons, 25 gallons, 30 gallons, 40 gallons, 50 gallons, 75 gallons, 100 gallons, 150 gallons, 200 gallons, 300 gallons, 500 gallons, 1000 gallons or more. The volumetric capacity of the brine tank body may be less than any of the values provided or may fall within a range between any two of the values provided. In some embodiments, the volumetric capacity of the brine body tank may be about 1 gallon to about 1,000 gallons. In some embodiments, the volumetric capacity of the brine body tank may be at least about 1 gallon. In some embodiments, the volumetric capacity of the brine body tank may be at most about 1,000 gallons. In some embodiments, the volumetric capacity of the brine body tank may be about 1 gallon to about 5 gallons, about 1 gallon to about 10 gallons, about 1 gallon to about 50 gallons, about 1 gallon to about 100 gallons, about 1 gallon to about 250 gallons, about 1 gallon to about 500 gallons, about 1 gallon to about 750 gallons, about 1 gallon to about 1,000 gallons, about 5 gallons to about 10 gallons, about 5 gallons to about 50 gallons, about 5 gallons to about 100 gallons, about 5 gallons to about 250 gallons, about 5 gallons to about 500 gallons, about 5 gallons to about 750 gallons, about 5 gallons to about 1,000 gallons, about 10 gallons to about 50 gallons, about 10 gallons to about 100 gallons, about 10 gallons to about 250 gallons, about 10 gallons to about 500 gallons, about 10 gallons to about 750 gallons, about 10 gallons to about 1,000 gallons, about 50 gallons to about 100 gallons, about 50 gallons to about 250 gallons, about 50 gallons to about 500 gallons, about 50 gallons to about 750 gallons, about 50 gallons to about 1,000 gallons, about 100 gallons to about 250 gallons, about 100 gallons to about 500 gallons, about 100 gallons to about 750 gallons, about 100 gallons to about 1,000 gallons, about 250 gallons to about 500 gallons, about 250 gallons to about 750 gallons, about 250 gallons to about 1,000 gallons, about 500 gallons to about 750 gallons, about 500 gallons to about 1,000 gallons, or about 750 gallons to about 1,000 gallons. In some embodiments, the volumetric capacity of the brine body tank may be about 1 gallon, about 5 gallons, about 10 gallons, about 50 gallons, about 100 gallons, about 250 gallons, about 500 gallons, about 750 gallons, or about 1,000 gallons.

The brine tank body without the lid may have a length of at least about 0.5 m, 1 m, 2.55 m

In some embodiments, the length of the brine tank body without a lid may be about 0.5 m to about 10 m. In some embodiments, the length of the brine tank body without a lid may be at least about 0.5 m. In some embodiments, the length of the brine tank body without a lid may be at most about 10 m. In some embodiments, the length of the brine tank body without a lid may be about 0.5 m to about 1 m, about 0.5 m to about 2 m, about 0.5 m to about 3 m, about 0.5 m to about 4 m, about 0.5 m to about 5 m, about 0.5 m to about 10 m, about 1 m to about 2 m, about 1 m to about 3 m, about 1 m to about 4 m, about 1 m to about 5 m, about 1 m to about 10 m, about 2 m to about 3 m, about 2 m to about 4 m, about 2 m to about 5 m, about 2 m to about 10 m, about 3 m to about 4 m, about 3 m to about 5 m, about 3 m to about 10 m, about 4 m to about 5 m, about 4 m to about 10 m, or about 5 m to about 10 m. In some embodiments, the length of the brine tank body without a lid may be about 0.5 m, about 1 m, about 2 m, about 3 m, about 4 m, about 5 m, or about 10 m.

In some embodiments, the length of the brine tank body without a lid may be may be about 0.5 m to about 3 m. In some embodiments, the length of the brine tank body without a lid may be about 0.5 m to about 0.7 m, about 0.5 m to about 0.9 m, about 0.5 m to about 1 m, about 0.5 m to about 1.2 m, about 0.5 m to about 1.5 m, about 0.5 m to about 1.7 m, about 0.5 m to about 2 m, about 0.5 m to about 2.2 m, about 0.5 m to about 2.5 m, about 0.5 m to about 2.7 m, about 0.5 m to about 3 m, about 0.7 m to about 0.9 m, about 0.7 m to about 1 m, about 0.7 m to about 1.2 m, about 0.7 m to about 1.5 m, about 0.7 m to about 1.7 m, about 0.7 m to about 2 m, about 0.7 m to about 2.2 m, about 0.7 m to about 2.5 m, about 0.7 m to about 2.7 m, about 0.7 m to about 3 m, about 0.9 m to about 1 m, about 0.9 m to about 1.2 m, about 0.9 m to about 1.5 m, about 0.9 m to about 1.7 m, about 0.9 m to about 2 m, about 0.9 m to about 2.2 m, about 0.9 m to about 2.5 m, about 0.9 m to about 2.7 m, about 0.9 m to about 3 m, about 1 m to about 1.2 m, about 1 m to about 1.5 m, about 1 m to about 1.7 m, about 1 m to about 2 m, about 1 m to about 2.2 m, about 1 m to about 2.5 m, about 1 m to about 2.7 m, about 1 m to about 3 m, about 1.2 m to about 1.5 m, about 1.2 m to about 1.7 m, about 1.2 m to about 2 m, about 1.2 m to about 2.2 m, about 1.2 m to about 2.5 m, about 1.2 m to about 2.7 m, about 1.2 m to about 3 m, about 1.5 m to about 1.7 m, about 1.5 m to about 2 m, about 1.5 m to about 2.2 m, about 1.5 m to about 2.5 m, about 1.5 m to about 2.7 m, about 1.5 m to about 3 m, about 1.7 m to about 2 m, about 1.7 m to about 2.2 m, about 1.7 m to about 2.5 m, about 1.7 m to about 2.7 m, about 1.7 m to about 3 m, about 2 m to about 2.2 m, about 2 m to about 2.5 m, about 2 m to about 2.7 m, about 2 m to about 3 m, about 2.2 m to about 2.5 m, about 2.2 m to about 2.7 m, about 2.2 m to about 3 m, about 2.5 m to about 2.7 m, about 2.5 m to about 3 m, or about 2.7 m to about 3 m. In some embodiments, the length of the brine tank body without a lid may be about 0.5 m, about 0.7 m, about 0.9 m, about 1 m, about 1.2 m, about 1.5 m, about 1.7 m, about 2 m, about 2.2 m, about 2.5 m, about 2.7 m, or about 3 m. In some embodiments, the length of the brine tank body without a lid may be at least about 0.5 m, about 0.7 m, about 0.9 m, about 1 m, about 1.2 m, about 1.5 m, about 1.7 m, about 2 m, about 2.2 m, about 2.5 m, about 2.7 m, about 3 m, or more. In some embodiments, the length of the brine tank body without a lid may be less than about 0.7 m, about 0.9 m, about 1 m, about 1.2 m, about 1.5 m, about 1.7 m, about 2 m, about 2.2 m, about 2.5 m, about 2.7 m, or about 3 m. The brine tank body without the lid may have a length of about 2.55 m.

In some embodiments, the length of the brine tank body without a lid may be about 2 m to about 10 m. In some embodiments, the length of the brine tank body without a lid may be about 2 m to about 2.5 m, about 2 m to about 3 m, about 2 m to about 3.5 m, about 2 m to about 4 m, about 2 m to about 4.5 m, about 2 m to about 5 m, about 2 m to about 6 m, about 2 m to about 7 m, about 2 m to about 8 m, about 2 m to about 9 m, about 2 m to about 10 m, about 2.5 m to about 3 m, about 2.5 m to about 3.5 m, about 2.5 m to about 4 m, about 2.5 m to about 4.5 m, about 2.5 m to about 5 m, about 2.5 m to about 6 m, about 2.5 m to about 7 m, about 2.5 m to about 8 m, about 2.5 m to about 9 m, about 2.5 m to about 10 m, about 3 m to about 3.5 m, about 3 m to about 4 m, about 3 m to about 4.5 m, about 3 m to about 5 m, about 3 m to about 6 m, about 3 m to about 7 m, about 3 m to about 8 m, about 3 m to about 9 m, about 3 m to about 10 m, about 3.5 m to about 4 m, about 3.5 m to about 4.5 m, about 3.5 m to about 5 m, about 3.5 m to about 6 m, about 3.5 m to about 7 m, about 3.5 m to about 8 m, about 3.5 m to about 9 m, about 3.5 m to about 10 m, about 4 m to about 4.5 m, about 4 m to about 5 m, about 4 m to about 6 m, about 4 m to about 7 m, about 4 m to about 8 m, about 4 m to about 9 m, about 4 m to about 10 m, about 4.5 m to about 5 m, about 4.5 m to about 6 m, about 4.5 m to about 7 m, about 4.5 m to about 8 m, about 4.5 m to about 9 m, about 4.5 m to about 10 m, about 5 m to about 6 m, about 5 m to about 7 m, about 5 m to about 8 m, about 5 m to about 9 m, about 5 m to about 10 m, about 6 m to about 7 m, about 6 m to about 8 m, about 6 m to about 9 m, about 6 m to about 10 m, about 7 m to about 8 m, about 7 m to about 9 m, about 7 m to about 10 m, about 8 m to about 9 m, about 8 m to about 10 m, or about 9 m to about 10 m. In some embodiments, the length of the brine tank body without a lid may be about 2 m, about 2.5 m, about 3 m, about 3.5 m, about 4 m, about 4.5 m, about 5 m, about 6 m, about 7 m, about 8 m, about 9 m, or about 10 m. In some embodiments, the length of the brine tank body without a lid may be at least about 2 m, about 2.5 m, about 3 m, about 3.5 m, about 4 m, about 4.5 m, about 5 m, about 6 m, about 7 m, about 8 m, about 9 m, about 10 m, or more. In some embodiments, the length of the brine tank body without a lid may be less than about 2.5 m, about 3 m, about 3.5 m, about 4 m, about 4.5 m, about 5 m, about 6 m, about 7 m, about 8 m, about 9 m, or about 10 m.

In some embodiments, the length of the brine tank body with a lid may be about 0.5 m to about 10 m. In some embodiments, the length of the brine tank body with a lid may be at least about 0.5 m. In some embodiments, the length of the brine tank body with a lid may be at most about 10 m. In some embodiments, the length of the brine tank body with a lid may be about 0.5 m to about 1 m, about 0.5 m to about 2 m, about 0.5 m to about 3 m, about 0.5 m to about 4 m, about 0.5 m to about 5 m, about 0.5 m to about 10 m, about 1 m to about 2 m, about 1 m to about 3 m, about 1 m to about 4 m, about 1 m to about 5 m, about 1 m to about 10 m, about 2 m to about 3 m, about 2 m to about 4 m, about 2 m to about 5 m, about 2 m to about 10 m, about 3 m to about 4 m, about 3 m to about 5 m, about 3 m to about 10 m, about 4 m to about 5 m, about 4 m to about 10 m, or about 5 m to about 10 m. In some embodiments, the length of the brine tank body with a lid may be about 0.5 m, about 1 m, about 2 m, about 3 m, about 4 m, about 5 m, or about 10 m.

In some embodiments, the weight of the brine tank body without any salt, water, or brine solution may be about 0.1 lbs to about 50 lbs. In some embodiments, the weight of the brine tank body without any salt, water, or brine solution may be at least about 0.1 lbs. In some embodiments, the weight of the brine tank body without any salt, water, or brine solution may be at most about 50 lbs. In some embodiments, the weight of the brine tank body without any salt, water, or brine solution may be about 0.1 lbs to about 0.5 lbs, about 0.1 lbs to about 1 lb, about 0.1 lbs to about 2 lbs, about 0.1 lbs to about 4 lbs, about 0.1 lbs to about 6 lbs, about 0.1 lbs to about 8 lbs, about 0.1 lbs to about 10 lbs, about 0.1 lbs to about 25 lbs, about 0.1 lbs to about 50 lbs, about 0.5 lbs to about 1 lb, about 0.5 lbs to about 2 lbs, about 0.5 lbs to about 4 lbs, about 0.5 lbs to about 6 lbs, about 0.5 lbs to about 8 lbs, about 0.5 lbs to about 10 lbs, about 0.5 lbs to about 25 lbs, about 0.5 lbs to about 50 lbs, about 1 lb to about 2 lbs, about 1 lb to about 4 lbs, about 1 lb to about 6 lbs, about 1 lb to about 8 lbs, about 1 lb to about 10 lbs, about 1 lb to about 25 lbs, about 1 lb to about 50 lbs, about 2 lbs to about 4 lbs, about 2 lbs to about 6 lbs, about 2 lbs to about 8 lbs, about 2 lbs to about 10 lbs, about 2 lbs to about 25 lbs, about 2 lbs to about 50 lbs, about 4 lbs to about 6 lbs, about 4 lbs to about 8 lbs, about 4 lbs to about 10 lbs, about 4 lbs to about 25 lbs, about 4 lbs to about 50 lbs, about 6 lbs to about 8 lbs, about 6 lbs to about 10 lbs, about 6 lbs to about 25 lbs, about 6 lbs to about 50 lbs, about 8 lbs to about 10 lbs, about 8 lbs to about 25 lbs, about 8 lbs to about 50 lbs, about 10 lbs to about 25 lbs, about 10 lbs to about 50 lbs, or about 25 lbs to about 50 lbs. In some embodiments, the weight of the brine tank body without any salt, water, or brine solution may be about 0.1 lbs, about 0.5 lbs, about 1 lb, about 2 lbs, about 4 lbs, about 6 lbs, about 8 lbs, about 10 lbs, about 25 lbs, or about 50 lbs.

In some embodiments, the cross-sectional area brine tank body may be about 0.1 square meters to about 10 square meters. In some embodiments, the cross-sectional area brine tank body may be at least about 0.1 square meters. In some embodiments, the cross-sectional area brine tank body may be at most about 10 square meters. In some embodiments, the cross-sectional area brine tank body may be about 0.1 square meters to about 0.5 square meters, about 0.1 square meters to about 1 square meter, about 0.1 square meters to about 2 square meters, about 0.1 square meters to about 4 square meters, about 0.1 square meters to about 6 square meters, about 0.1 square meters to about 8 square meters, about 0.1 square meters to about 10 square meters, about 0.5 square meters to about 1 square meter, about 0.5 square meters to about 2 square meters, about 0.5 square meters to about 4 square meters, about 0.5 square meters to about 6 square meters, about 0.5 square meters to about 8 square meters, about 0.5 square meters to about 10 square meters, about 1 square meter to about 2 square meters, about 1 square meter to about 4 square meters, about 1 square meter to about 6 square meters, about 1 square meter to about 8 square meters, about 1 square meter to about 10 square meters, about 2 square meters to about 4 square meters, about 2 square meters to about 6 square meters, about 2 square meters to about 8 square meters, about 2 square meters to about 10 square meters, about 4 square meters to about 6 square meters, about 4 square meters to about 8 square meters, about 4 square meters to about 10 square meters, about 6 square meters to about 8 square meters, about 6 square meters to about 10 square meters, or about 8 square meters to about 10 square meters. In some embodiments, the cross-sectional area brine tank body may be about 0.1 square meters, about 0.5 square meters, about 1 square meter, about 2 square meters, about 4 square meters, about 6 square meters, about 8 square meters, or about 10 square meters.

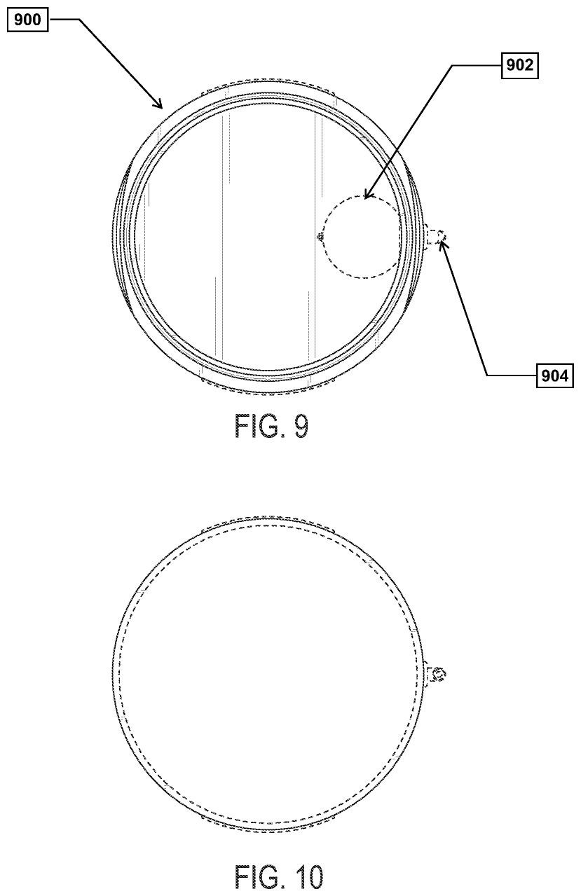

The brine tank body 108 may further comprise an overflow fitting 110. In some cases, the tank body 108 may further comprise a narrow base 112. The additional narrow base may expand the volumetric capacity of the brine tank. It may also enable stacking of two or more lid-less brine tanks. The tank body 108 may have a label 116. The brine tank body further comprises a brine well, a barrier that keeps the sodium and/or potassium salts that may be used to generate the brine solution for the ion exchange process. FIG. 9 provides an exemplary brine tank body 900 with a brine well 902 and an overflow fitting 904.

The brine tank provided herein may be located outside where it may be exposed to inclement weather. Under such conditions, the lid of the brine tank needs to be able to withstand harsh weather conditions such as strong winds that may have uplift wind load, shear wind load, and/or lateral wind load. For example, the lid of the brine tank may be able to withstand winds with a speed range of 1-3 mph; at least 4-7 mph; 8-12 mph; 13-18 mph; 19-24 mph; 25-31 mph; 32-38 mph; 39-46 mph; or 47-54 mph. In some embodiments, when the brine tank may be covered with the lid, the lid stays on the brine tank for winds with a speed for at least about 1 mph, about 4 mph, about 8 mph, about 13 mph, about 19 mph, about 25 mph, about 32 mph, about 39 mph, or about 47 mph.

Additionally, the brine tank may need to be able to withstand temperature cycles when located in places that cycle between hot and cold climates. The temperature changes may result in expansion and/or contraction of the lid and/or brine tank body.

To remain on the brine tank during inclement weather, the lid may have an interference fit, a location/transition fit, or a clearance fit with the top of the brine tank body. In some cases, when the lid may be on the brine tank body, it may form a hermetic of fluid-type seal. The hermetic seal may remain substantially intact when the tank is tripped over or rolled over.

The brine tank body may further comprise one or more indentations to assist a user/operator to remove a lid from the brine tank body. The one of the one or more indentations may be separate; in some embodiments, the indentations may only partially traverse around the circumference of the brine tank body. In some embodiments, the indentations may go completely around the circumference of the brine tank body. The indentations may be separate and selective indentations. One or more separate and selective indentations may be used to remove a lid from the brine tank body. In some embodiments, the separate and selective indentations may be used at the same time substantially simultaneously to remove a lid from the brine tank body. In some embodiments, at most one, two, three, four, five, or more separate and selective indentations may be used at the same time substantially simultaneously to remove a lid from the brine tank body. The indentations (e.g., the separate and selective indentations) may make it easier for a user to remove the lid since the user would know where to apply the force and/or would not have to guess a spot to apply the force to open the lid with optimum force. Additionally, the separate indentations may provide the lid with a tighter constant and less likely to fall off. The space between the indentations may act as support for the user/operator when applying the force to remove the lid. Additionally, the separation of the indentations (i.e. indentation that partially traverses around the circumference of the brine tank body) decreases the likelihood that something may get caught in the indentation and apply enough force to lift the lid accidentally. For example, an indentation that does not traverse around the entire circumference of the brine tank body may have a lower likelihood of being pushed open by a force from a source other than a user. For example, if a brine tank is tripped over or being rolled, a force may be applied to the lid by a source (e.g., wall, floor, or a random object); the indentations described herein have a limited surface area therefore a lower likelihood of being pushed open compared to an indentation that may traverse around the circumference of the tank. Keeping the indentations separate may ease manufacturing and/or may extend the lifespan of the brine tank, making it a more durable and robust product.

The separate indentations with relatively small surface area compared to an indentation that may traverse around a substantially larger curve around the circumference of the tank or the entire circumference of the tank may also improve a sanitation condition of the tank. A relatively smaller surface area may have a lower likelihood of being contaminated by unsanitary substances (e.g., dirt, toxic substances, oily substances, etc.) and/or biological contaminations (e.g., bacterial growth, virus contamination, etc.)

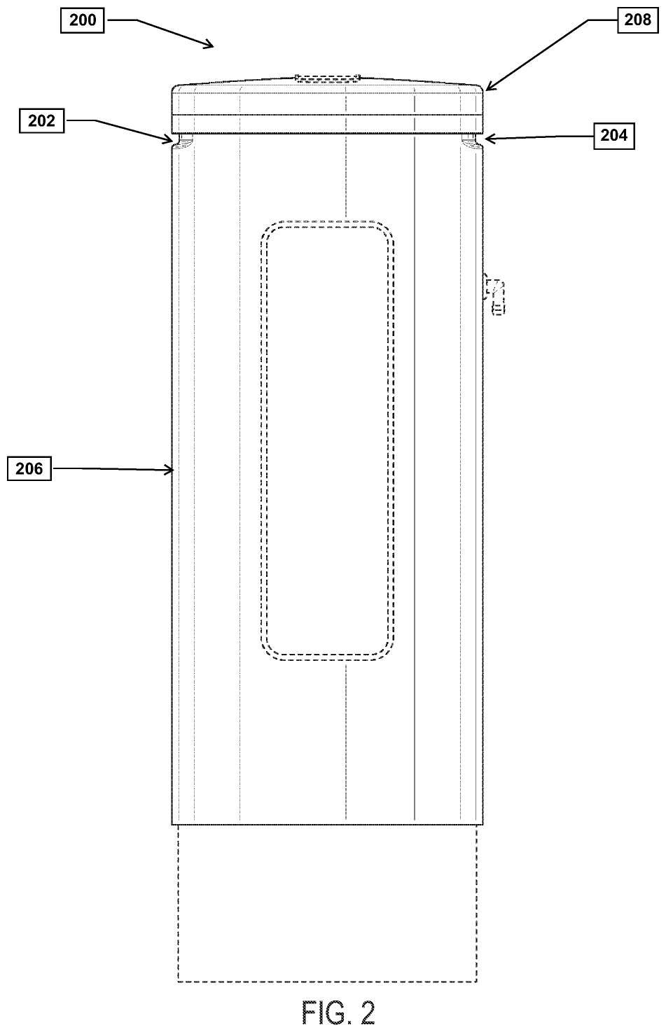

The user/operator may slide fingers into the one or more indentations to apply force to the lid. In an exemplary embodiment of a brine tank 200, two indentations, 202 and 204, are shown in FIG. 2. The indentations may be located on the tank body 206. In this exemplary embodiment, a user/operator can place fingers in the indentation 202 and/or indentation 204 and apply force to the lid 208 in order to separate the lid from the brine tank body. The applied force needed to remove the lid may be in the vertical (i.e. parallel to the brine tank body and/or lid), horizontal (i.e. perpendicular to the brine tank body and/or lid), circumferential (i.e. along the circumference of the brine tank body and/or lid), or a combination thereof. In some cases, the applied force may have a vertical component and horizontal component, wherein the vertical component may be greater than the horizontal component. In some cases, the applied force may have a vertical component and horizontal component, wherein the horizontal component may be greater than the vertical component. In some cases, the applied force may have a vertical component and a circumferential component, wherein the vertical component may be greater than the circumferential component. In some cases, the applied force may have a vertical component and a circumferential component, wherein the circumferential component may be greater than the vertical component.

The applied force needed to remove the lid may be less than about 1 N, 2 N, 3 N, 4 N, 5 N, 6 N, 8 N, 10 N, 15 N, 20 N, 25 N, 30 N, 40 N, 50 N, 75 N, 100 N, 150 N, 200 N, 300 N, 500 N, or 1000 N. The applied force may be more than any of the values provided herein or may fall within a range between any two of the values provided herein. The force required to remove the lid may be within a range that allows for manual removal of the lid without a use of a tool or an auxiliary object. In some embodiments, the lid may be removed substantially easily by an individual (e.g., without a tool, or pry open with a tool). In some embodiments, the separate indentations may facilitate the easier removal of the lid by allowing more focused force to be applied to the lid.

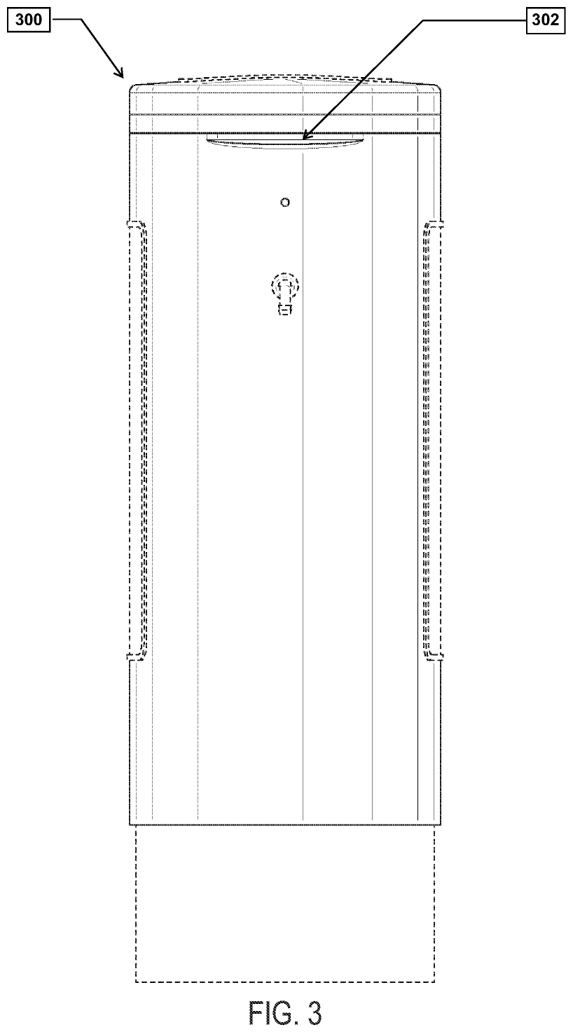

The one or more indentations may have a partial circular shape; a partial rectangular shape; or a substantial polygonal shape. The width of the indentation may be less than about one-hundredth ( 1/100), one-seventy-fifth ( 1/75), one-fiftieth ( 1/50), one-thirtieth ( 1/30), one-twentieth ( 1/20), a tenth ( 1/10), a fifth (⅕) or a third (⅓) of the circumference of the brine tank. FIG. 3 provides an exemplary brine tank 300 with an indentation 302 having a polygonal shape.

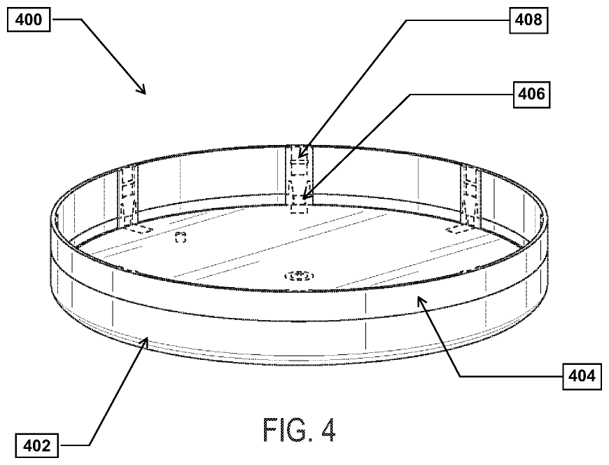

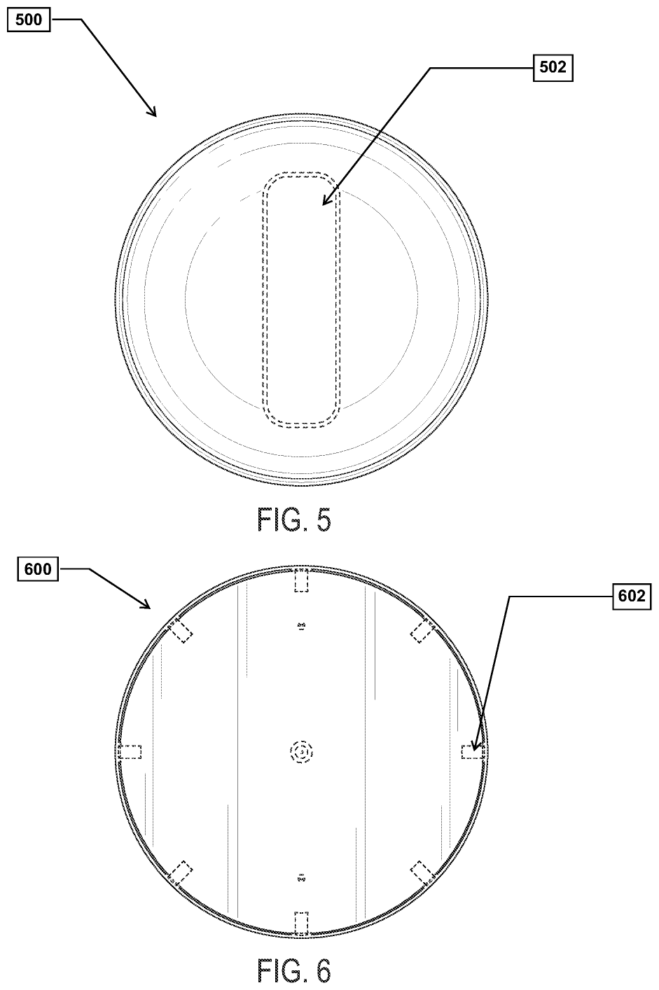

An exemplary brine tank lid 400, shown in FIG. 4, comprises two parts: the first part 402 and the second part 404. The first part 402 may be coupled to the second part 404 via one or more fastening mechanisms on the first part 406 and/or the second part 408. In some embodiments, the fastening mechanisms 406 and 408 snap together. In some embodiments, the fastening mechanisms 406 and 408 can be separated to uncouple the first part 402 from the second part 404. FIG. 6 also illustrates an exemplary brine tank lid 600 with several fastening mechanism units 602. In some embodiments, the fastening mechanisms 406 and/or 408 produce one or more protrusions on the surface of the first part 402 and/or the second part 404. The one or more protrusions may create friction or resistance so that the lid does not easily separate from the tank body when substantially no force may be applied.

Examples of fastening mechanisms may include, but are not limited to, complementary threading, form-fitting pairs, hooks and loops, latches, threads, screws, staples, clips, clamps, prongs, rings, brads, rubber bands, rivets, grommets, pins, ties, snaps, Velcro, adhesives (e.g., glue), tapes, vacuum, seals, magnets, magnetic seals, a combination thereof, or any other types of fastening mechanisms.

In some instances, the first part 402 and the second part 404 can be fastened to each other via one or more pairs of complementary fastening units 406 and 408. For example, the fastening unit 406 of the first part 402, and the fastening unit 408 of the second part 404 can complete a form-fitting pair. In some instances, the fastening unit 406 of the first part 402 can comprise a form-fitting male component and the fastening unit 408 of the second part 404 can comprise a form-fitting female component, and/or vice versa. In some instances, an outer diameter of a protrusion-type fastening unit of the fastening unit 406 of the first part 402 can be substantially equal to an inner diameter of a depression-type fastening unit of the fastening unit 408 of the second part 404, or vice versa, to form an interference fit. Alternatively, or in addition, a pair of the two fastening units can comprise other types of complementary units or structures (e.g., hook and loop, latches, snap-ons, buttons, nuts and bolts, magnets, etc.) that can be fastened together. Alternatively or in addition, a pair of the two fastening units can be fastened using other fastening mechanisms, such as but not limited to staples, clips, clamps, prongs, rings, brads, rubber bands, rivets, grommets, pins, ties, snaps, Velcro, adhesives (e.g., glue), magnets or magnetic fields, tapes, a combination thereof, or any other types of fastening mechanisms.

In some instances, the fastening unit 406 of the first part 402 and the fastening unit 408 of the second part 404 can be fastened to each other via an intermediary structure. The intermediary structure may be a linker or connector between the fastening unit 406 of the first part 402 and the fastening unit 408 of the second part 404. In some instances, the intermediary structure may be fastened to one or both of the fastening unit 406 of the first part 402 and the fastening unit 408 of the second part 404 through one or more of any of the fastening mechanisms described herein. The intermediary structure may be solid. The intermediary structure may be liquid or gas. The intermediary structure may be a gel. In some instances, the intermediary structure may be applied as one phase (e.g., liquid) and transform into another phase (e.g., solid) after passage of time such as to achieve the fastening. For example, the intermediary structure may comprise a fluid adhesive that solidifies to achieve the fastening. In some instances, the intermediary structure may be capable of transforming from a first phase to a second phase, such as from liquid to solid or from solid to liquid, upon application of a stimulus (e.g., thermal change, pH change, pressure change, magnetic field, electric field, etc.) to achieve fastening or unfastening (or both). In some instances, the fastening unit 406 of the first part 402 and/or the fastening unit 408 of the second part 404 may comprise the intermediary structure. For example, the intermediary structure may be integral to the fastening unit 406 of the first part 402 and/or the fastening unit 408 of the second part 404. In some instances, the he fastening unit 406 of the first part 402 and/or the fastening unit 408 of the second part 404, in part or entirely, may be capable of transforming from a first phase to a second phase, such as from liquid to solid or from solid to liquid, upon application of a stimulus (e.g., thermal change, pH change, pressure change, magnetic field, electric field, etc.) to achieve fastening or unfastening (or both) to the other part.

The fastening between the fastening unit 406 of the first part 402 and the fastening unit 408 of the second part 404 can be temporary, such as to allow for subsequent unfastening of the two parts without damage (e.g., permanent deformation, disfigurement, etc.) to the two parts or with minimal damage. In some embodiments, the two parts may be permanently fastened or temporarily fastened to one another. In some embodiments, the two parts may be detachable or repeatedly removeable. Alternatively, the fastening can be permanent, such as to allow for subsequent unfastening of the two parts only by breaking at least one of the two parts. One of the two parts, or both, can be temporarily or permanently deformed (e.g., stretched, compressed, etc.) and/or disfigured (e.g., bent, wrinkled, folded, creased, etc.) or otherwise manipulated when fastened to each other or during fastening. In some instances, one or both of the two parts can be cut into or pierced by the other when the two parts may be fastened together. In some embodiments, the two parts may be formed separately from one another to have similar or distinct properties (e.g., colors, textures, materials or patterns). The two parts may have different visual characteristics to be distinguished substantially easily. In some embodiments, the two parts may have different colors.

In some instances, the lid of a brine tank may have a label. For example, the exemplary brine tank lid 500 may be a label 502.

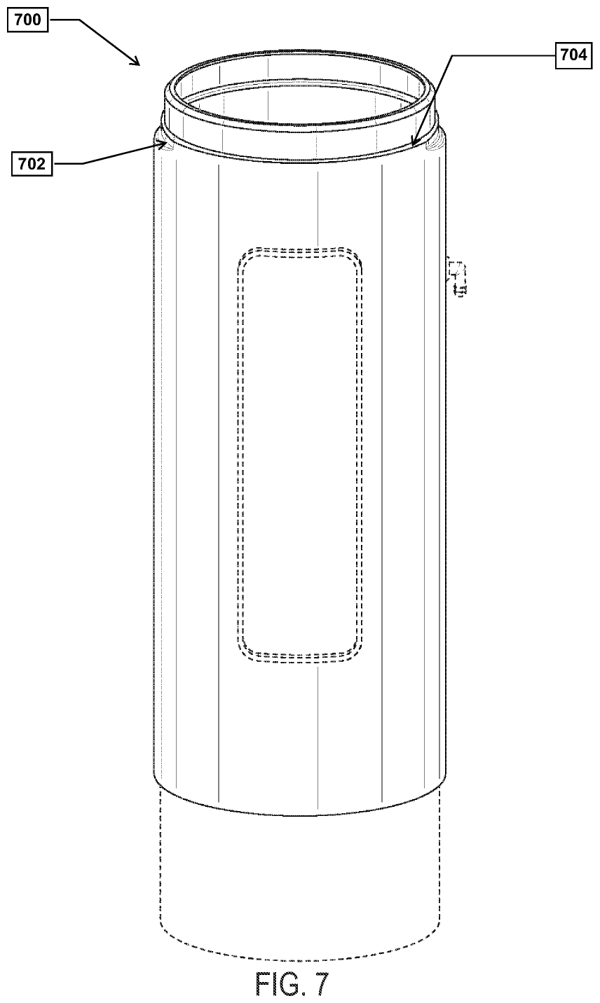

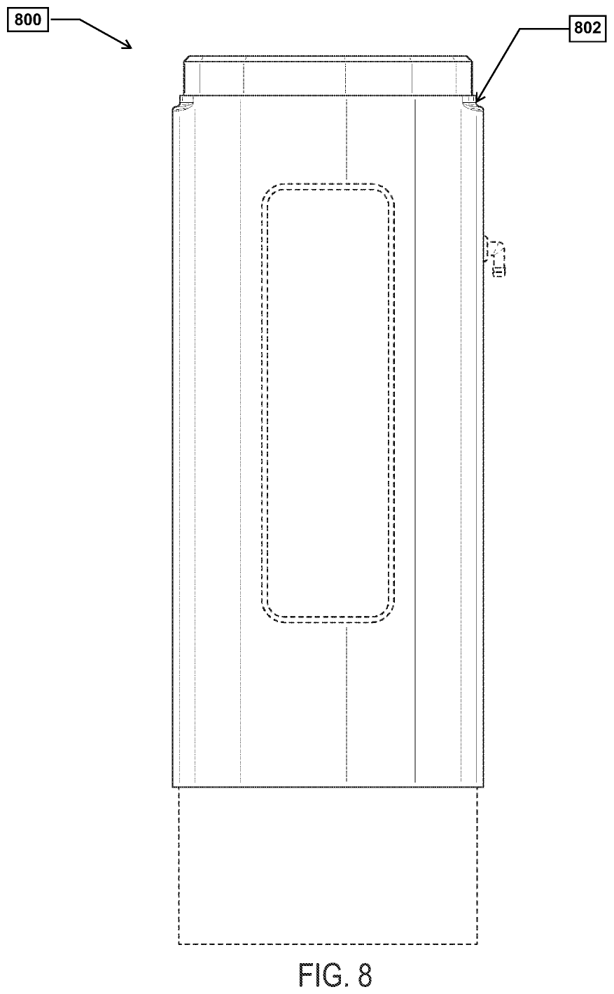

In some cases, the brine tank body may have a ledge on which the brine tank lid may sit when the brine tank may be assembled. In an exemplary embodiment shown in FIG. 7, a brine tank 700 has a ledge 704. In this exemplary embodiment, an indentation 702 may be positioned below the ledge 704. When the brine tank may be the assembled state, the location of the indentation 702 beneath the ledge 704 may allow a user/operator to apply a force to the lid sitting on the ledge to remove the lid. In another exemplary embodiment of the brine tank body 800, the indentation 802 may be located beneath the ledge.

The brine tank provided herein, including the brine tank lid and the brine tank body, may be produced via injection molding, blow molding, 3D printing, casting, or a combination thereof. In some embodiments, the brine tank body may be produced by blow molding. In some embodiments, the brine tank lid, including the first and second parts, may be produced by injection molding.

In some cases, injection molding may be the preferred method of manufacturing the brine tank lid and/or brine tank body. In such cases, it may be difficult or even impossible to produce a lid with two different colored parts in one injection molding process. To address this issue, the lid may comprise two parts, a first part with a first color and a second part with a second color. By having two parts, injection molding may be used to create each of the two parts of the lids. The two parts may be then assembled and connected via one or more fastening mechanisms as described herein to produce the brine tank lid. In fact, the first part and the second part of the brine tank lid described herein may be produced via injection molding.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A brine tank configured to generate brine solution and to support flow of brine solution to a water softener for regeneration of an ion-exchange resin, comprising:
(a) a brine tank lid comprising a first part having a first fastening unit and a second part having a second fastening unit, the first part and the second part coupled to each other, and the first fastening unit and the second fastening unit are complementary to each other and can snap together to form the brine tank lid; and
(b) a brine tank body,
wherein the brine tank body comprises a plurality of indentations configured to allow an operator to apply a force to the brine tank lid and separate the brine tank lid from the brine tank body, and
wherein the plurality of indentations are positioned to be at least partially exposed when the brine tank lid is attached to the brine tank body.

2. The brine tank of claim 2, wherein the plurality of indentations are separately spaced from one another along a circumference of the brine tank body.

3. The brine tank of claim 1, wherein the one of the plurality of indentations has a partial circular shape; a partial rectangular shape; or a substantial polygonal shape.

4. The brine tank of claim 1, wherein a width of one of the plurality of indentations is less than about a fifth (⅕) of the circumference of the brine tank.

5. The brine tank of claim 1, wherein the brine tank body has a volumetric capacity of at least about 10 gallons.

6. The brine tank of claim 1,
wherein the first part comprises a first color, and the second part comprises a second color; and
wherein the first color and the second color are different.

7. The brine tank of claim 6, wherein the first color has a first wavelength, and the second color has a second wavelength, and wherein a difference of the first wavelength and the second wavelength is at least 50 nm.

8. The brine tank of claim 6, wherein the first color is black, and the second color is orange with a wavelength of about 590 to about 625 nm.

9. (canceled)

10. (canceled)

11. The brine tank of claim 1, wherein the first fastening unit and the second fastening unit comprise one or more protrusions.

12. The brine tank of claim 11, wherein the one or more protrusions are configured to create friction or resistance between the brine tank lid and the brine tank body.

13-18. (canceled)

19. A residential water filtration system comprising a brine tank configured to generate brine solution for regeneration of ion-exchange resin, wherein the brine tank body comprises:
(a) a brine tank lid comprising a first part having a first fastening unit and a second part having a second fastening unit, the first part and the second part coupled to each other, and the first fastening unit and the second fastening unit are complementary to each other and can snap together to form the brine tank lid; and
(b) a brine tank body.

20. The residential water filtration system of claim 30, wherein the plurality of indentations are separately spaced from one another along a circumference of a brine tank body.

21. The residential water filtration system of claim 30, wherein the plurality of indentations has a partial circular shape; a partial rectangular shape; or a substantial polygonal shape.

22. The residential water filtration system of claim 30, wherein a width of one of the plurality of indentations is less than about a fifth (⅕) of the circumference of the brine tank.

23. The residential water filtration system of claim 19, wherein the first part comprises a first color, and the second part comprises a second color; wherein the first color and the second color are different.

24. The residential water filtration system of claim 23, wherein the first color is black, and the second color is orange with a wavelength of about 590 to about 625 nm.

25. (canceled)

26. (canceled)

27. The brine tank of claim 1, wherein the plurality of indentations are sized and configured to receive fingers of a user when the brine tank lid is attached to the brine tank body.

28. The residential water filtration system of claim 30, wherein the plurality of indentations are sized and configured to receive fingers of a user when the brine tank lid is attached to the brine tank body.

29. The brine tank of claim 1, wherein the brine tank body defines an interior cavity sized to retain a quantity of salts for production of a brine solution, the brine tank body having an outer wall and an upper lip inset from the outer wall to define a stepped upper opening, the brine tank further comprising:
a brine well received in the brine tank body, the brine well positioned to provide a barrier to keep the quantity of salts out of the brine well.

30. The residential water filtration system of claim 19, wherein the brine tank body comprises a plurality of indentations configured to allow an operator to apply a force to the brine tank lid and separate the brine tank lid from the brine tank body, and wherein the plurality of indentations are positioned to be at least partially exposed when the brine tank lid is attached to the brine tank body.

31. A brine tank configured to generate brine solution and to support flow of brine solution to a water softener for regeneration of an ion-exchange resin, comprising:
(a) a brine tank lid comprising a first part having a first fastening unit and a second part having a second fastening unit, the first part and the second part coupled to each other, and the first fastening unit and the second fastening unit are complementary to each other; and
(b) a brine tank body,
wherein the brine tank body comprises a plurality of indentations configured to allow an operator to apply a force to the brine tank lid and separate the brine tank lid from the brine tank body, and
wherein the plurality of indentations are positioned to be at least partially exposed when the brine tank lid is attached to the brine tank body, and
wherein the fastening unit and the second fastening unit comprise one or more protrusions, the protrusions configured to create friction or resistance between the brine tank lid and the brine tank body.

32. The brine tank of claim 31, wherein the plurality of indentations are separately spaced from one another along a circumference of the brine tank body.

33. The brine tank of claim 31, wherein the one of the plurality of indentations has a partial circular shape; a partial rectangular shape; or a substantial polygonal shape.

34. The brine tank of claim 31, wherein a width of one of the plurality of indentations is less than about a fifth (⅕) of the circumference of the brine tank.

35. The brine tank of claim 31, wherein the brine tank body has a volumetric capacity of at least about 10 gallons.

36. The brine tank of claim 31, wherein the plurality of indentations are sized and configured to receive fingers of a user when the brine tank lid is attached to the brine tank body.
